(19) United States
(12) Patent Application Publication
(10) Pub. No.: US 2025/0025903 A1
(43) Pub. Date: Jan. 23, 2025

(54) SPRAY MIST DETECTION IN PROCESS PLANTS

(71) Applicant: Endress+Hauser SE+Co. KG, Maulburg (DE)

(72) Inventors: Ulrich Heitz, Lorsch (DE); Dietmar Haag, Weil am Rhein (DE); Klaus Feißt, Stegen (DE)

(21) Appl. No.: 18/715,378

(22) PCT Filed: Nov. 21, 2022
(86) PCT No.: PCT/EP2022/082665

§ 371 Date: May 31, 2024

(30) Foreign Application Priority Data
Dec. 15, 2021 (DE) 10 2021 133 185.4

(51) Int. Cl. B05B 12/00; G01F 23/284

(52) U.S. Cl. CPC B05B 12/004; G01F 23/284

(57) ABSTRACT

The detection of spray mist in containers and the associated checking of the functioning of the corresponding spray head by a high-frequency measuring device includes transmitting a high-frequency signal into the container and receiving a corresponding reception signal after reflection in the container. A defined characteristic variable that can be assigned to the spray mist is determined on the basis of the reception signal. The presence of spray mist is detected if the determined characteristic variable corresponds to a predefined reference value. To use this as the basis to detect the functionality of the spray head, it is additionally necessary to control or detect the activation and deactivation of the spray head. This allows the spray head to be classified as functional if it is switched on, and the high-frequency measuring device detects the spray mist.

The invention relates to the detection of spray mist or to the checking of the functioning of spray heads in process plants.

In process automation, corresponding field devices are used for capturing relevant process parameters. For the purpose of capturing the different process parameters, suitable measuring principles are therefore implemented in the corresponding field devices, in order to capture as process parameters, for example, a fill-level, a flow, a pressure, a temperature, a pH value, a redox potential, or a conductivity. The Endress+Hauser corporate group manufactures and distributes a wide variety of field devices.

For measuring the fill level of filling materials in containers, high-frequency-based transit-time measuring methods have become established, because they are robust and require minimum maintenance. In the context of the invention, the term “high frequency” is defined either as radar or as ultrasound with frequencies between 20 kHz and 300 GHz. A further advantage of high-frequency-based measuring methods consists in the ability to be able to measure the fill level quasi-continuously. Radar-based measuring methods are therefore predominantly used in the field of continuous fill-level measurement (in the context of this patent application, “radar” refers to signals or electromagnetic waves with frequencies between 0.03 GHz and 300 GHz). In the case of radar and ultrasound, the pulse transit time method has become established as a transit-time measuring method. The FMCW (frequency-modulated continuous-wave) method is also increasingly being used in the field of radar. Transit-time-based fill-level measurement is described in greater detail in “Radar Level Detection,” Peter Devine, 2000, for example.

In process containers in which the fill level is to be measured, container cleaning is often carried out—for example, for disinfection in the food sector. Cleaning is carried out using one or more spray heads, which is/are installed to be stationary in the container on the side or on the top, in order to distribute the corresponding cleaning agent as a spray mist in a defined spray pattern in the container. Arrangements of spray heads, the spray heads or spray patterns of which rotate, are also used to achieve a greater distribution of the spray mist in the container. Such spray heads are manufactured by GEA Tuchenhagen GmbH, for example.

Correct functioning of the spray heads is essential, particularly for disinfection in the food sector, because otherwise the filling material in the container can become contaminated. It is therefore important for the process plant to have information on whether the spray head(s) is/are functioning properly. There may be a malfunction, for example, if the spray head does not spray a mist, or if the spray head or spray pattern does not rotate even though the spray head is switched on.

In the prior art, acoustic measuring devices that acoustically monitor the material flow of the liquid in the spray heads are often used to monitor the proper functioning of the spray heads. However, the disadvantage of this is that such measuring devices are often disrupted by general process noise, such as pumps, agitators, and inflows and outflows, meaning that the desired monitoring of the spray mist cannot be reliably guaranteed. In addition, sufficient sensitivity of these measuring devices is guaranteed only in the immediate vicinity of the spray head to be monitored. This requires at least one measuring device to be installed per spray head, which is expensive when using multiple spray heads and often leads to space problems during assembly.

The object of the invention is therefore to be able to monitor the function of spray heads in containers reliably and with little measuring effort.

The invention achieves this object by a method for detecting spray mist in a container by means of a high-frequency measuring device, the method comprising at least the following method steps:
transmitting a high-frequency signal into the container,
receiving a reception signal after the transmitted high-frequency signal is reflected in the container,
determining a defined characteristic variable on the basis of the reception signal, and
detecting spray mist if the determined characteristic variable corresponds to a predefined reference value.

The corresponding high-frequency measuring device must for this purpose comprise at least the following components:
a signal generation unit which is designed to generate the high-frequency signal to be transmitted,
an antenna arrangement, by means of which the high-frequency signal can be transmitted towards spray mist, and by means of which the reception signal can be received, and
an evaluation unit, which is designed
   to use the reception signal to determine the characteristic variable, and
   to detect spray mist if the determined characteristic variable corresponds to the reference value.

Since radar and ultrasound-based fill-level measuring devices generally comprise these necessary components, it is particularly synergetic to use a high-frequency-based fill-level measuring device, which is provided per se and is used to determine the fill level of the filling material in the container, to carry out the method according to the invention. In the context of the invention, it is not relevant whether the high-frequency signals are radar or ultrasonic signals. If the high-frequency or fill-level measuring device is designed as a radar-based measuring device, it is again irrelevant whether the signal generation unit is designed to transmit the high-frequency signal by means of the pulse transit time method or the FMCW method. The evaluation unit must be designed to correspond to the signal generation unit. This means that the evaluation unit must receive or process the reception signal according to the pulse transit time method or by means of the FMCW method.

At least in the case of the pulse transit time method and the FMCW method, the reception signal reproduces the amplitude curve with high temporal resolution. Accordingly, reflective objects, such as the spray mist, are reproduced in the reception signal as a signal maximum, and the signal transit time corresponding to the signal maximum reflects the distance of the spray mist to the antenna arrangement. Accordingly, as part of the method according to the invention, the reception signal can be used to determine an amplitude, for example, in particular that of a signal maximum, as a characteristic variable. Depending upon the constitution of the spray mist, the reflection of the radar signal from the spray mist at the corresponding location of the reception signal can already cause a dedicated signal maximum. In this case, the evaluation unit can determine the amplitude of this signal maximum in particular from the reception signal as a characteristic variable. On the basis of the amplitude or the characteristic variable, not only can the presence of any spray mist be detected, but also a spray quantity of the spray mist in relation to the reference value, the unit of which quantity is, for example, liters or cubic meters per minute.

Since radar or ultrasonic signals are diffusely reflected by spray mist according to the constitution thereof, the amplitude of the signal maximum that can be assigned to the reflection of the high-frequency signal on an inner wall of the container, such as the container bottom, or on a filling material, can also be determined as a characteristic variable. This is because, if there is spray mist in the path of the high-frequency signal, the amplitude of this signal maximum reduces considerably. Due to the diffuse reflection, a characteristic noise can also be produced in the reception signal. Therefore, alternatively or additionally, a corresponding noise value can also be determined from the reception signal as a relevant characteristic variable.

On the basis of the method described above or on the basis of the corresponding high-frequency measuring device, a measuring system can be designed according to the invention by means of which the functionality of the spray head spraying the spray mist into the process container with a defined spray pattern can be determined. The measuring system must include at least the following components:
a high-frequency measuring device according to one of the preceding embodiments, wherein the antenna arrangement is oriented in the direction of the spray pattern—optimally, approximately orthogonal to the spray pattern—and
a higher-level unit, which is designed
   to control or detect the activation and deactivation of the spray head,
   to query the detection of spray mist by the high-frequency measuring device, and
   to classify the at least one spray head as functional if it is switched on, and the high-frequency measuring device detects spray mist.

If the method according to the invention is repeated over a plurality of measurement cycles, it is also conceivable in the context of the invention that any periodicity with which the characteristic variable changes periodically within the measurement cycles be determined. This can be used in particular with rotating spray heads or rotating spray patterns, as it allows correct rotation or the periodicity thereof to be checked. In this case, the higher-level unit designed accordingly can classify the at least one spray head as functional if the higher-level unit determines a defined periodicity with which the characteristic variable changes periodically within the measurement cycles, and if the spray head is demonstrably switched on.

In the context of the invention, the term “unit” is understood in principle to mean any separate arrangement or encapsulation of the electronic circuits that are provided for a specific application—for example, for high-frequency signal processing or as an interface. Depending upon the application, the corresponding unit may therefore comprise corresponding analog circuits for generating or processing corresponding analog signals. However, the module can also comprise digital circuits, such as FPGA's, microcontrollers, or storage media in conjunction with appropriate programs. The program is designed to carry out the required method steps or to apply the necessary computing operations. In this context, different electronic circuits of the unit in the sense of the invention can also potentially access a common physical memory or be operated by means of the same physical digital circuit. In this case, it does not matter whether different electronic circuits within the unit are arranged on a common printed circuit board, or on multiple, interconnected printed circuit boards.

The invention is explained in more detail on the basis of the following figure, which shows:

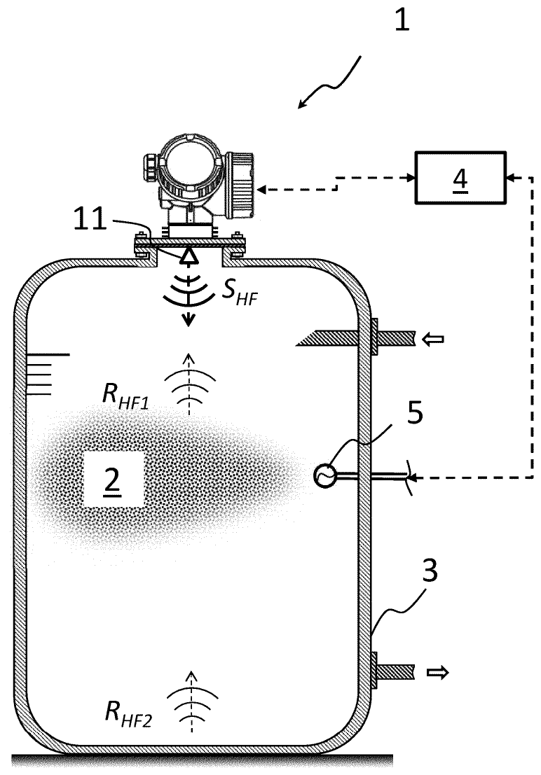

FIG. 1: a radar-based fill-level measuring device for checking the functioning of a spray head in a container.

To understand the invention, a container 3 of an industrial process plant is shown in FIG. 1. In this case, the container 3 can be up to more than 100 m tall, depending upon the field of application. The conditions in the container 3 depend upon the field of application and the type of filling material: In applications in the food industry, for example, it is necessary to monitor fermentation processes, in which the filling material is pumped out of the container 3 at the end of the fermentation process. A radar-based fill-level measuring device 1 is arranged at a container opening on the top in order to monitor the fill level during filling and pumping, among other things. Depending upon the measuring method implemented, the fill-level measuring device 1 transmits radar signals S_{HF} vertically downwards via an antenna arrangement 11 according to the pulse transit time or FMCW method and receives corresponding reception signals R_{HF} after reflection on the liquid or the container bottom.

In order to clean the inside of the container 3 before refilling or before starting the subsequent fermentation process, a spray head 5 is arranged at a lateral container opening. For this purpose, the spray head 5, when switched on, sprays a cleaning agent or disinfectant, for example, with a defined spray pattern. In contrast to the simplified illustration in FIG. 1, it is common for a plurality of spray heads 5 to be distributed in the container 3 so that the corresponding spray patterns fill the space around the container 3 as completely as possible.

In general, the fill-level measuring device 1 and the spray head 5 are each connected to a higher-level unit 4, such as a local process control system or a decentralized server system, via a separate interface, such as “4-20 mA,” “PROFIBUS,” “HART,” or “Ethernet.” In this way, the measured fill-level value can be transmitted, for example, in order to control, as necessary, the flow to or discharge from the container 3. However, other information about the general operating state of the fill-level measuring device 1 can also be communicated. The higher-level unit 4 can also switch the spray head 5 on and off via the interface, for example.

According to the invention, the higher-level unit 4, the fill-level measuring device 1, and the spray head 5 form, via the interfaces, a common measuring system by means of which the correct function of the spray head 5 can be checked. The advantage of this is that no separate measuring device has to be installed to test the spray head 5; rather, the functioning is tested by means of the fill-level measuring device 1. In contrast to the embodiment shown in FIG. 1, however, it is also conceivable in the context of the invention to use, instead of the fill-level measuring device 1, a separate high-frequency measuring device that is equipped with a corresponding signal generation unit, antenna arrangement, and evaluation unit analogously to the fill-level measuring device 1, in order to generate or transmit the radar signal S_{HF} and to determine corresponding characteristic variables on the basis of the reception signal R_{HF1}, R_{HF2}.

A fault of the spray head 5 can be a blockage, for example, so that the spray head 5 sprays a noticeably reduced spray mist 2, or none at all, when switched on. If the spray head 5 is designed in such a way that it additionally rotates when switched on and therefore pivots the spray pattern accordingly, an interruption of the periodic pivoting can also be a malfunction. These types of malfunctions can be detected by the measuring system by the fill-level measuring device 1 also transmitting a radar signal S_{HF} during the spraying process, i.e., when the container 3 is free of filling material. In this way, the invention utilizes the effect by which the spray mist 2 can be detected in the reception signal R_{HF} by means of characteristic variables. This can be caused, for example, by the immediate reflection of the radar signal R_{HF1} on the spray mist 2, or a reduced reflection of the radar signal R_{HF2} on the container bottom.

This manifests itself in the reception signal R_{HF}, among other things, by the amplitude of the corresponding signal maximum or by increased noise. The characteristic variables are all the more apparent if the spray head 5, as shown in FIG. 1, is arranged as orthogonally as possible to the transmitting/receiving direction of the fill-level measuring device 1. In this way, the fill-level measuring device 1 or the higher-level unit 4 can use the amplitude of the corresponding signal maximum or the noise level in the reception signal R_{HF} to deduce the presence of the spray mist 2. If the spray head 5 is designed to rotate, this also manifests itself in the reception signal R_{HF} by the characteristic variable changing with the corresponding temporal periodicity. To detect any periodicity, it is necessary for the fill-level measuring device 1 to continuously transmit the radar signal S_{HF} over at least the corresponding time period or the corresponding measurement cycles. In connection with this, a delay time between switching on the spray head 5 or spray heads and the start time of the periodicity can also be detected by means of the higher-level unit 4. In this case, a degree of wear of the rotating mechanism can be assigned to the delay time, so that maintenance can be initiated if necessary.

The higher-level unit 4 can detect one or more of these characteristic variables either by requesting the characteristic variable(s) from the fill-level measuring device 1 via the interface or by forwarding the reception signal R_{HF} from the fill-level measuring device 1 to the higher-level unit 4 for relevant further processing.

In order to be able to detect the presence of spray mist 5 on the basis of the determined characteristic variable, or to be able to check the correct function of the spray head 5, the higher-level unit 4 must compare the relevant characteristic variable with a corresponding reference value, which is determined under known conditions. It is obvious to record the reference value or the underlying reception signal R_{HF}, for example, as part of a calibration mode of the fill-level measuring device 1 at a time when the container 3 is empty, and the spray head 5 is in operation and demonstrably functioning correctly. If a subsequent comparison between the characteristic variable recorded in regular spraying operation and the reference value results in a match, it can be deduced from this that spray mist 2 is present.

Furthermore, to be able to check the correct function of the spray head 5, the higher-level unit 4 must query whether the spray head 5 is currently switched on, in addition to comparing the determined characteristic variable with the reference value. This information is available to the higher-level unit 4 per se if said unit also controls the activation and deactivation of the spray head 5. If the comparison matches—and if the spray head 5 is switched on—it can be concluded from this according to the invention that the spray head 5 is in fact functioning. In the other case, i.e., if the spray head 5 is switched on, but the comparison does not result in a match, a malfunction of the spray head 5 can be deduced.

The same applies to the determination of any periodicity: If the higher-level unit 4 detects a periodicity of the defined characteristic variable and if the spray head 5 is demonstrably switched on, it can be concluded from this according to the invention that the spray head 5 is rotating properly.

In contrast to the embodiment shown in FIG. 1, in which the measuring system monitors the function of only a single spray head 5, it is also conceivable to check the function of multiple spray heads 5 by means of the one fill-level measuring device 1 if the spray patterns of said spray heads are located in the transmitting/receiving cone of the antenna arrangement 11. In this case, too, all spray heads 5 can be considered to be functioning if they are demonstrably switched on, and the comparison of the characteristic variable with the reference value shows a match. In the event that the higher-level unit 4 or the fill-level measuring device 1 does not establish a match, it can be deduced that at least one of the spray heads 5 is malfunctioning. In order to check the function of each individual spray head 5 by means of a single fill-level measuring device 1, it is of course also possible to switch the individual spray heads 5 on or off successively, e.g., within a test operation, and to determine for each individual spray head a separate characteristic variable, which allows a statement to be made about the functionality of the individual spray head 5 by comparing said variable with a particular reference value. This means that the measuring system according to the invention requires only a few components, even in the case of multiple spray heads 5. Alternatively, if the function of all spray heads 5 is to be checked individually, it is of course also conceivable to provide a separate high-frequency measuring device 1 for each individual spray head 5 or each individual spray pattern.

### LIST OF REFERENCE SIGNS

1 Radar-based measuring device
2 Spray mist
3 Container
4 Higher-level unit
5 Spray head
11 Antenna arrangement
R_{HF1,2} Reception signal
S_{HF} Radar signal

1-12. (canceled)

13. A method for detecting spray mist in a container via a high-frequency measuring device, the method comprising:
transmitting a high-frequency signal into the container;
receiving a reception signal after the transmitted high-frequency signal is reflected in the container;
determining a defined characteristic variable on the basis of the reception signal; and
detecting the spray mist when the determined characteristic variable corresponds to a predefined reference value.

14. The method according to claim 13, wherein the reception signal is used to determine a noise, an amplitude, or a signal maximum as the characteristic variable.

15. The method according to claim 14, further comprising:
determining an amplitude of the signal maximum that can be assigned to the reflection of the high-frequency signal on an inner wall of the container or on a filling material.

16. The method according to claim 14, further comprising:
determining an amplitude of the signal maximum that can be assigned to the reflection of the high-frequency signal on any spray mist.

17. The method according to claim 13, further comprising:
determining a spray quantity of the spray mist on the basis of the characteristic variable.

18. The method according to claim 13, wherein the method is repeated over a plurality of measurement cycles, the method further comprising:
determining a periodicity with which the characteristic variable changes periodically within the measurement cycles.

19. A high-frequency measuring device for detecting a spray mist in a container, the high-frequency measuring device comprising:
a signal generation unit which is designed to generate a high-frequency signal to be transmitted;
an antenna arrangement via which the high-frequency signal can be transmitted towards the spray mist, and via which a reception signal can be received; and
an evaluation unit which is designed:
to use the reception signal to determine a characteristic variable; and
to detect the spray mist when the determined characteristic variable corresponds to a predefined reference value.

20. The high-frequency measuring device according to claim 19,
wherein the high-frequency measuring device is designed as a radar-based measuring device,
wherein the signal generation unit is designed to transmit the high-frequency signal via a pulse transit time method or via a frequency-modulated continuous wave method, and
wherein the evaluation unit is designed to receive or process the reception signal accordingly.

21. A measuring system for checking a functionality of a spray head that is arranged in a container and that is designed to spray a spray mist inside the container with a defined spray pattern, the measuring system comprising:
a high-frequency measuring device, including:
a signal generation unit which is designed to generate a high-frequency signal to be transmitted, including:
an antenna arrangement via which the high-frequency signal can be transmitted towards the spray mist, and via which a reception signal can be received; and
an evaluation unit which is designed:
to use the reception signal to determine a characteristic variable; and
to detect the spray mist when the determined characteristic variable corresponds to a predefined reference value,
wherein the antenna arrangement is oriented in a direction of the spray pattern; and
a higher-level unit, which is designed:
to control or detect the activation and deactivation of the spray head;
to query the detection of spray mist by the high-frequency measuring device; and
to classify the spray head as functional if it is switched on and the high-frequency measuring device detects spray mist.

22. The measuring system according to claim 21, wherein the higher-level unit is designed to classify a rotation of the spray head as functional if the spray head is switched on and a periodicity with which the characteristic variable changes periodically within the measurement cycles is determined.

23. The measuring system according to claim 22, wherein the high-frequency measuring device is arranged to transmit a radar signal orthogonally to the spray pattern.
